(19) United States
(12) Patent Application Publication
(10) Pub. No.: US 2006/0075033 A1
(43) Pub. Date: Apr. 6, 2006

(54) Method and system for creating and sending electronic mail having multi-media files

(76) Inventors: Terry S. Bienstock, Miami Beach, FL (US); Bruce Hertzfeld, Narberth, PA (US); Eric Budin, Rosemont, PA (US)

Correspondence Address: BROOKS KUSHMAN P.C., 1000 TOWN CENTER, TWENTY-SECOND FLOOR, SOUTHFIELD, MI, 48075, US

(21) Appl. No.: 10/945,086

(22) Filed: Sep. 20, 2004

(51) Int. Cl. G06F 15/16

(52) U.S. Cl. 709/206

(57) ABSTRACT

A method and system for creating and sending electronic mail messages having multi-media files. The method and system include creating the multi-media file in an email application used to create an email message without having to exit the email application. The multi-media file is added to the email message and sent to a recipient. The multi-media file is removed by a server prior to deliverance of the email message to the recipient. The removed file is replaced with a link to the removed file so that the recipient can click on the link and view the multi-media file.

### BACKGROUND OF THE INVENTION

1. Field of the Invention

The present invention relates to an electronic mail (email) system and method for sending multi-media files with email messages.

2. Background Art

An electronic messaging system is a system for sending electronic mail (email). An email message is essentially an electronic form of the common paper message that is created on a computer and delivered through a network using a messaging system as opposed to a paper message that is created on paper and sent through the mail.

One problem with known email systems relates to the inability of such systems to provide a user-friendly means for including video, audio, pictures, or similar multi-media files with the email message. One known means for sending a multi-media file with an email includes attaching a multi-media file to the message such that the attached file is delivered as part of the email to the recipient's computer. In order to read the email, the recipient must download the email, including the attached multi-media file, which can be rather large in data size, from a server or other device(s) used to route the email from the sender's computer to the recipient's computer. The delivery of the attached video file to the recipient's computer in this manner can be problematic.

Another problem with known email systems relates to the process of attaching the multi-media file to the email message. In particular, some email programs may be incompatible with the multi-media recording program used to record the multi-media file, such that the sender may be unable to attach a multi-media file to their email. Another problem is that the multi-media file may require recording with a multi-media program that runs separately from an email program such that the recorded file must be merged with the email program. Another problem is that the recipient may be unaware of the size or content of the attached multi-media file until after the download process begins, which can cause the recipient to download a large file that they would not otherwise download if the size or content of the file was known. Another problem is that the recipient must have a computer program that is compatible with a format of the multi-media file, which can be inconvenient as the recipient may be forced to wait through a long download process only to determine that they lack an appropriate program for playing the file.

### SUMMARY OF THE INVENTION

It is, therefore, an object of the present invention to provide a method and system for sending multi-media files with email messages that overcomes the above-identified problems of the prior art.

The present invention contemplates a number of features for sending multi-media files with email messages, including a system having a computer and a server. The computer is configured with an email application of the present invention that integrates a multi-media feature with the email application such that a user can compose an email message in the email application and create and/or add a multi-media file to the email message from the email application, such as without exiting the email application or in the same window as in which the email message is composed. The system further includes a server configured in accordance with the present invention for relaying the email message having the multi-media file. The server is configured to remove the multi-media file from the email message and replace it with a link. The removed multi-media file is stored on the server and accessible through the link. The email with the multi-media file replaced by the link is sent to the recipient, whereby the recipient can view the multi-media file by clicking on the link.

In one aspect of the present invention, the multi-media feature is configured to create and/or automatically add a video file to the email message. In another aspect of the present invention, the multi-media feature is configured to create and/or automatically add an audio file to the email message. In another aspect of the present invention, the multi-media feature is configured to create and/or automatically add a greeting card file to the email message. In another aspect of the present invention, the multi-media feature is configured to create and/or automatically add a slide show file to the email message.

### BRIEF DESCRIPTION OF THE DRAWINGS

FIG. 1 illustrates a system for sending a multi-media file with an email message in accordance with one aspect of the present invention;

FIG. 2 illustrates a graphical user interface (GUI) of an email application of the present invention;

FIG. 3 illustrates a GUI for generating a multi-media message in accordance with the present invention;

FIG. 4 illustrates a window of the GUI configured for recording a video file in accordance with the present invention;

FIG. 5 illustrates a window in the GUI configured for recording an audio multi-media file in accordance with the present invention;

FIG. 6 illustrates a window in the GUI configured for creating a greeting card multi-media file in accordance with the present invention;

FIG. 7 illustrates a window in the GUI configured for displaying available greeting cards in accordance with the present invention;

FIG. 8 illustrates a window in the GUI configured for customizing a greeting card in accordance with the present invention;

FIG. 9 illustrates a window in the GUI configured for adding a slide show multi-media file in accordance with the present invention; and

FIG. 10 illustrates a message sent from a server in accordance with the present invention.

### DETAILED DESCRIPTION OF THE PREFERRED EMBODIMENT(S)

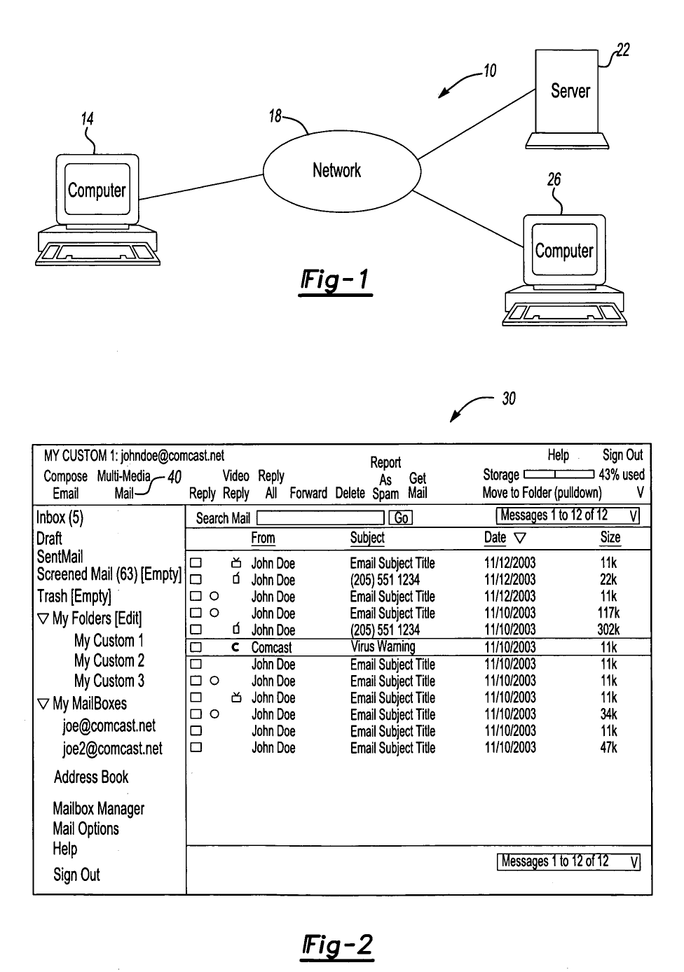

FIG. 1 illustrates a system 10 in accordance with one aspect of the present invention for sending a multi-media file with an electronic mail (email) message. For the purposes of the present invention, such a message is referred to as a multi-media message, however, the use of this term is not intended to limit the scope of the present invention. The present invention contemplates a broad meaning for the term “multi-media” to include any static, animated, audio, visual, and/or audio-visual presentation of graphics, pictures, recorded images, and the like.

The system includes a sender computer 14, a network 18, a server 22, and a recipient computer 26. A sender creates the multi-media message on the sender computer 14 with the assistance of an email application of the present invention that allows the user to create a multi-media message. The multi-media message is delivered from the computer 14 over the network 18 to the server 22. The server 22 hosts a webpage or other network accessible interface that a recipient of the multi-media message can access via the recipient computer 26 to view the message.

The network 18 can include any electronic means for communicating signals between the computers 14 and 26 and the server 22, including a public telephone switching network (PTSN), a wireless network, a cable network, a satellite network, and the like. The server 22 can include any type of messaging or hosting server that includes a memory, processor, means for communicating with the network 18, and the like.

The sender computer 14 and the recipient computer 26 can include any computing device that includes a memory, processor, means for communicating with the network 18, and the like. The present invention contemplates other features and devices for the system, including the computers 14 and 26 being a hand-held device, a mobile phone, a personal digital assistant (PDA), and the like. The system 10 shown in FIG. 1 is only one exemplary aspect of the present invention and is not intended to limit the scope of the present invention, as other structures and features are contemplated.

FIG. 2 illustrates a GUI 30 of the email application of the present invention that provides an email interface in accordance with one aspect of the present invention. The email interface operates with an email program or other system of the computer for accessing email features provided by an email messaging service offered by a provider of the server 22. There are a number of such email services, and the present invention contemplates operation with any number of them, including email services offered by internet service providers, such as telephone companies, cable companies, and others.

The email interface is intended to encompass any email system, whether the email system operates solely on a computer or on an internet applet that communicates with the server 22. The illustrated interface is shown to include a number of buttons and input fields for generating email messages. Unless otherwise specified, the operation of these various buttons and fields for sending email messages is understood by one having ordinary skill in the art and a description of the operation and usage of these features is not provided.

The GUI 30 provides a user interface on the screen of the computers 14 and 26 that allows users to navigate and control the GUI 30 by using a mouse or other pointer device to point, click, and drag icons, buttons, dialogue boxes, and other data on the screen. Input fields and the like are included for inputting text and other instructions to the GUI 30. The GUI 30 primarily relies on this use of pictures, images, and other icons to represent the input and output functions required for creating the multi-media message in accordance with the present invention. This allows the GUI 30 to be more user-friendly and to present content for selectable control in an appealing format. The GUI 30 can operate on any operating system, including Windows, MacOS, Acorn, RISC, OS, NEXTSTEP, Linux, and the like.

The GUI 30 initially sends signals from the sender computer 14 to the server 22 with initialization of the email application. The server 22 interprets the signals for logging in and authenticating the user. In accordance with one aspect of the present invention, the authentication of the user by the server 22 is used to control access and features of the GUI 30, such as to automatically deliver the user's email to the computer 14 for display in the GUI 30. This allows the server 22 to specify content and the like based on the user, and in particular, based on a services contract for the user. The server can then limit access and track billing charges based on the authenticated user.

In accordance with one aspect of the present invention, the email application allows the sender to create a multi-media message without requiring the sender to operate a separate multi-media program that runs as an application independent of the email application. The present invention is able to provide this feature by integrating multi-media functionality with the email interface so that the user can easily add multi-media elements to the email while operating inside the email application. This integrated approach for multi-media messaging is provided when the user clicks on a “multi-media mail” button 40 included on the GUI.

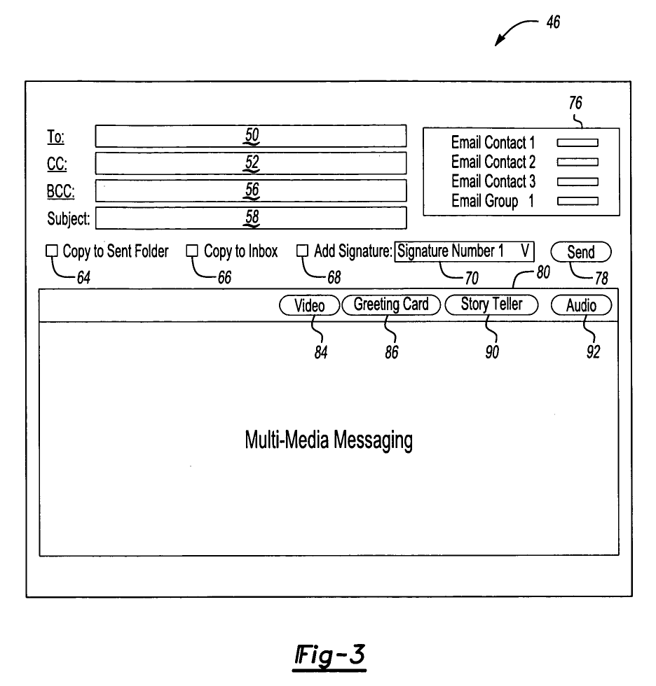

FIG. 3 illustrates a GUI 46 that appears with selection of the “multi-media mail” button 40 for generating a multi-media message in accordance with one aspect of the present invention. The GUI 46 includes a number of input fields and menus for inputting information. One input field is a “To” input field 50 into which a recipient email address is entered to designate a recipient of the message. Similarly, a “CC” input field 52 is provided for entering an email address for a courtesy-copy and a “BCC” input field 56 is provided for entering an email address for a blind courtesy-copy. A “Subject” input field 58 is provided for entering a subject of the multi-media message. A check box 64 is provided for saving a copy of the message to a sent folder, and a check box 66 is provided for saving a copy of the message to an inbox, a check box 68 is provided for adding a signature selected from a drop down menu 70. A group menu 76 is provided with additional check boxes to select the address of the recipient from predefined lists of recipients, i.e., an email contact 1, an email contact 2, an email contact 3 and an email group 1. Of course, more of less of these email features may be included without deviating from the scope and contemplation of the present invention. A “Send” button 78 is selected to electronically mail the message to the recipient.

The GUI 46 includes an applet that is presented in a window 80 for customizing the message to include a multi-media file. The multi-media file can be included with the email message in a variety of formats, which are selectable by actuation one of a “Video” button 84, a “Greeting Card” button 86, a “Story Teller” button 90, and an “Audio” button 92. Each button 84-92 provides a feature for adding the multi-media file with the message in accordance with the present invention.

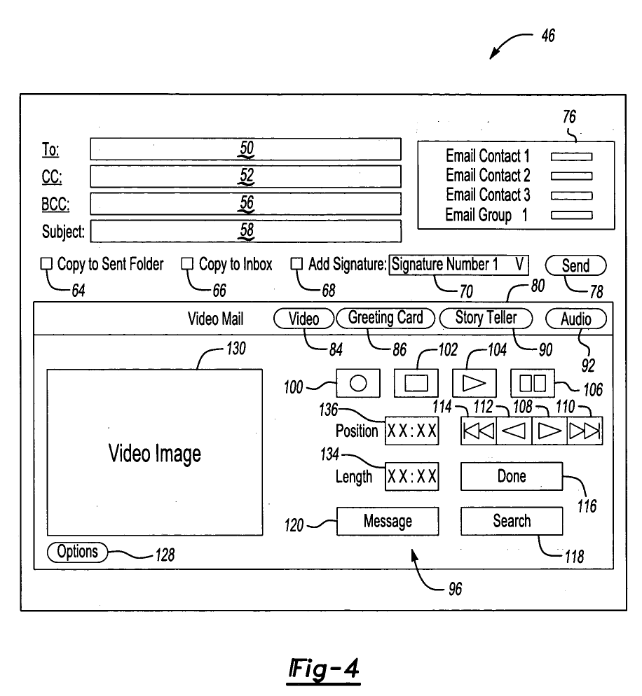

FIG. 4 illustrates the window 80 configured for recording a video file, which appears with selection of the “Video” button 84. The selection of the “Video” button 84 prompts the applet to provide an operation menu 96 in the window 80 for controlling the recording of a video file. The operation menu 96 includes a number of selectable buttons, including a record button 100, a stop button 102, a play button 104, a pause button 106, a forward button 108, a fast forward button 110, a rewind button 112, a fast rewind button 114, a “Done” button 116, a “Search” button 118, and a “Message” button 120.

Selection of the record button 100 initiates a video recording process a whereby the GUI 46 executes instructions to the computer to locate a peripheral recording device (not shown) associated with the computer 14, such as a video camera and microphone, and to begin recording the video. In accordance with one aspect of the present invention, the video is recorded in a format compatible with the server 22 so that the video can be easily sent to the server 22 without requiring the sender to operate secondary recording applications. An “Options” button 128 is selectable for displaying an interface for assistance with locating the peripheral device and/or for setting the recording options of the peripheral device, such as the video format.

The recorded video images recorded by the peripheral recording device are shown in a display window 130 so that the sender can instantaneously view the images during recording and play-back, which can be helpful for positioning the device, adjusting the recording options, and monitoring the recording video. A “Length” indicator 134 displays a running time of the recording in hours and minutes. The stop button 102 is selected to stop the video recording. The recorded video is stored on the computer 14 and attached to the message.

The play button 104 is selected to play the recorded video in the window 130 and the pause button 106 is selected to pause the playing video. The recorded video can be edited by stopping the video at a desired position and re-recording from there by again selecting the record button 100. A “Position” indicator 136 displays a time position in hours and minutes of the position of the image shown in the window 130 relative to the running time indicated in the “Length” indicator 134 to facilitate locating portions of the video, which can be helpful when editing the video. The forward button 110, fast forward button 110, rewind button 112, and fast rewind button 114 are each separately selectable for scanning through the recorded video.

The “Search” button 118 is selected to located video previously stored on the computer 14. A separate file folder window (not shown) can appear with selection of the “Search” button 118 and/or enhanced functionality can be provided by automatically locating and displaying video found on the computer 14 in the file folder window. The stored video can be selected from the file folder window for playing in the display window 130. The functions described above, such as the editing, recording, and other operations can be similarly performed on the stored video once it is loaded for display in the window 130. Of course, the present invention does not require recording of video, but rather video clips to be included with the e-mail message may be selected from any pre-recorded video stored on or imported to the computer 14.

The “Done” button 116 is selected to attach the recorded video file to the message. The sender can add a text message to the email my selecting the “Message” button 120, which causes a window (not shown) having an input field to appear for inputting the text message. Optionally, the window for entering the text message could be shown within the GUI 46 to eliminate the extra step of selecting the “Message” button.

In addition to, or instead of the video file, the sender can include other multi-media files with the message by selecting the “Greeting Card” button 86, the “Story Teller” button 90, and/or the “Audio” button 92.

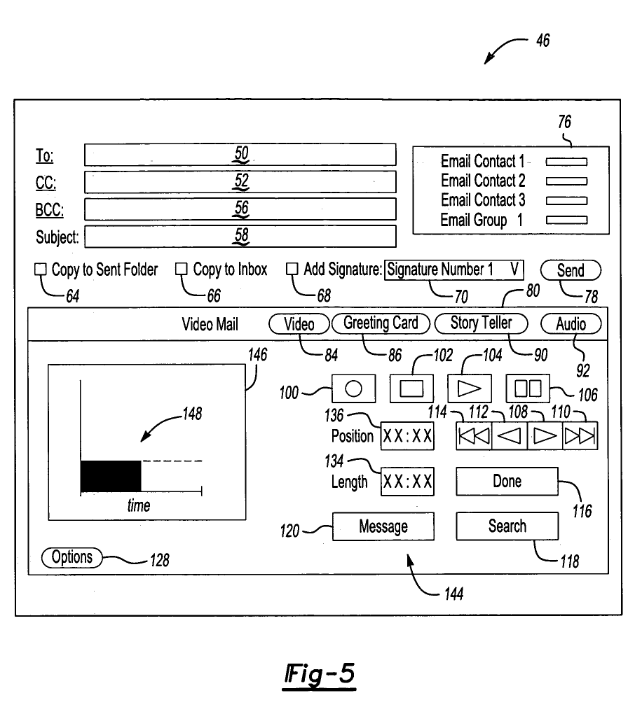

FIG. 5 illustrates the window 80 configured for recording an audio multi-media file, which appears with selection of the “Audio” button 92. The selection of the “Audio” button 92 prompts the GUI 46 to reconfigure the applet running in the window 80 to provide an operations menu 144 for controlling the recording of an audio multi-media file. The operation menu 144 includes a number of selectable buttons which are designated with the same reference numerals recited above with respect to recording a video multi-media file. Rather than locating a video camera or the like, selection of the “Audio” button 92 prompts the GUI 46 to instruct the computer 14 to locate peripheral devices (not shown) for recording the audio file, such as a microphone. The audio file is then recorded to the computer 14 as described above with respect to the video file, including the same functionality for monitoring, recording, and editing the audio. A window 146 displays a run time graph 148 that indicates the recording time of the end of file. As above, the present invention does not require recording of audio, but rather a pre-recorded audio file stored on or imported to the computer 14 could alternatively be included in the e-mail message.

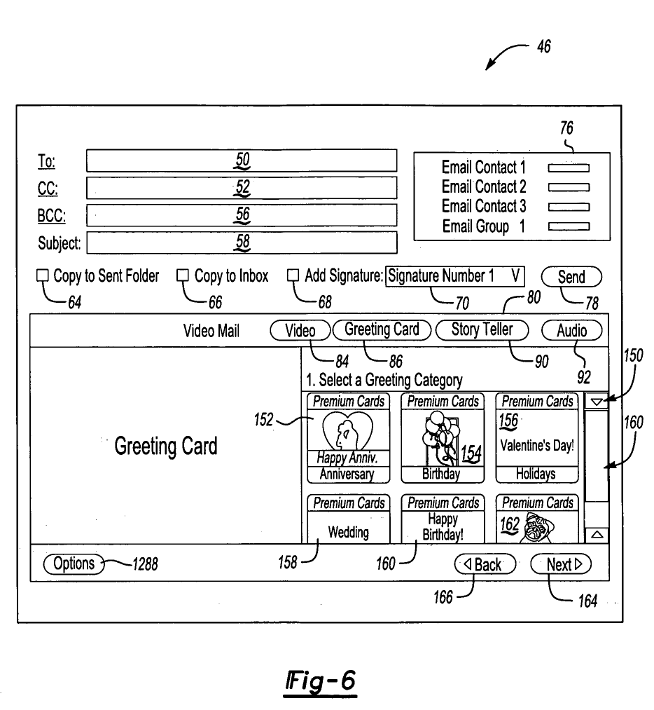

FIG. 6 illustrates the window 80 configured for creating a greeting card multi-media file, which appears with selection of the “Greeting Card” button 86. The selection of the “Greeting Card” button 86 prompts the GUI 46 to reconfigure the applet running in the window 80 to provide a menu 150 for creating a greeting card file. The menu 150 includes a number of thumbnails 152-162 that correspond with different greeting card categories.

The thumbnails 152-162 are downloaded to the computer 14 with selection of the “Greeting Card” button 86 and/or the greeting card thumbnails 152-162 can be stored on the memory of the computer 14 and periodically updated by downloading and storing new thumbnails during the authentication process. The available greeting card categories can be based on the service contract of the sender such that the displayed greeting cards are determined based on a user profile, and in particular, based on whether the user has signed up for a premium or non-premium package. The premium package typically costs more than the non-premium package but preferably provides a wider array of greeting cards.

Each greeting card thumbnail 152-162 provides a preview of the greeting card category, such as “wish you well” cards, birthday cards, and holiday cards, such as “Happy Mother's Day,” etc. The menu 150 can include navigation buttons 160 and the like to facilitate browsing of the available greeting card categories. The desired category of greeting card is selected by selecting one of the thumbnails 152-162 and then selecting a “Next” button 164. Selecting of the “Next” button displays the greeting cards available for the selected category, which can also be tailored based on the user profile. A “Back” button 166 is selected to return to the menus shown in FIG. 3, however, each button 84-92 can be selected to call up the corresponding menu.

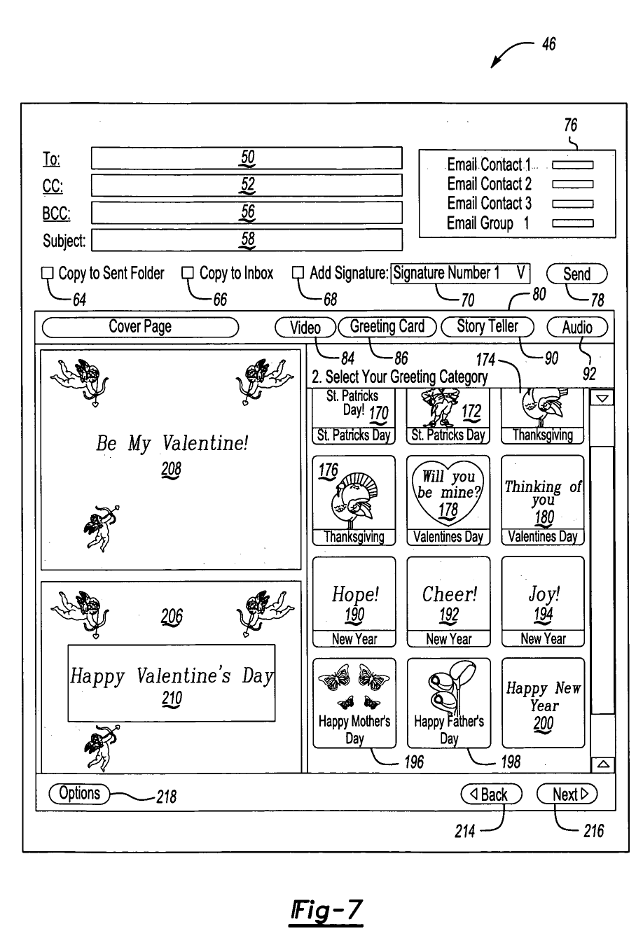

FIG. 7 illustrates the window 80 reconfigured to display the greeting cards available for a selected category. The greeting cards shown in the window 80 correspond with selection of the thumbnail 156 for holiday cards. The thumbnails 170-200 generally show a cover page graphic for the greeting cards and allow the user to preview the available greeting cards prior to selecting the desired card. The server 22 can deliver any number greeting cards to the sender and tailor the greeting cards to current holidays and user specified criteria.

Like paper greeting cards, the electronic greeting cards of the present invention include a cover page and an inside page, of course more or less pages can be included without deviating from the scope and contemplation of the present invention. The thumbnail 180 of the desired greeting card is selected to display the cover page and the inside page in windows 206 and 208, respectively. The cover page generally conveys the content of the card with a graphical and textual expression. The inside page of the card includes similar expressions, and generally, includes a longer textual description in a message portion 210 that details a message to be conveyed by the card. The greeting cards can include any number of multi-media features and graphics, such as animations and the like.

A “Back” button 214 is selected to return to the greeting card category menu 150 shown in FIG. 6 so that the user can select another greeting card category. A “Next” button 216 is selected from the menu shown in FIG. 7 to customize the desired greeting card. An “Options” button 218 is selected to display an options menu (not shown) that allows the user to change their user profile and to request different greeting cards than those displayed in the menu. In accordance with one aspect of the present invention, the options menu can provide a pay-per-use or other feature for requesting additional greeting cards.

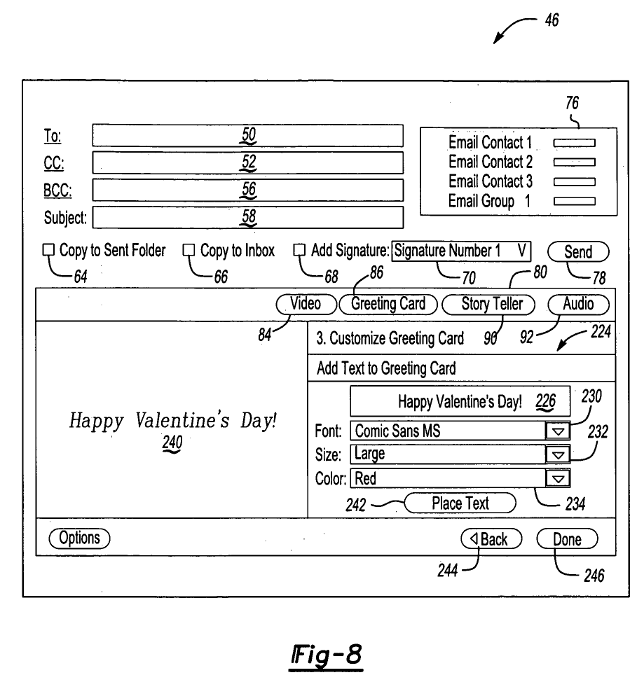

FIG. 8 illustrates the window 80 having a message customization menu 224 that appears to customize the message of the selected greeting card with selecting of the “Next” button 216 of FIG. 7 in accordance with one aspect of the present invention. Typically, the cover page is not customized and thus the customization menu automatically appears for the inside page, however, a similar customization menu can be provided for customizing the cover page and/or navigation features can be provide for switching between editing menus for the cover page and inside page. The text for the inside page automatically appears in an input window 226 so that the message conveyed thereby can be changed or added to by positioning the pointer within the window and typing in a new message. A number of drop-down menus are provided for controlling the appearance of a message font, including a font menu 230 for selecting a font type, a size menu 232 for selecting a font size, and a color menu 234 for selecting a font color.

The customized font and message are previewed in a window 240 with selection of a “Place Text” button 242, which places the inputted text in the window as it would appear on the inside page of the greeting card. Additional features can be included for adding other items to the greeting cards, such as animation, video, sound, and the like. Such items may be downloaded from the server with the available greeting cards or stored on the computer 14. The present invention contemplates electronic greeting cards having more or less pages than the described cover and inside pages. Additional features can be included for editing these pages, such as a page selection button (not shown) that configures the customization menu 224 for editing a selected page in the greeting card.

A “Back” button 244 is selected to return to the menu shown in FIG. 7 for selecting the greeting card. A “Done” button 246 is selected once the editing of the greeting card is completed to return to the menu shown in FIG. 3 so that the message can be sent or so that additional multi-media elements can be added.

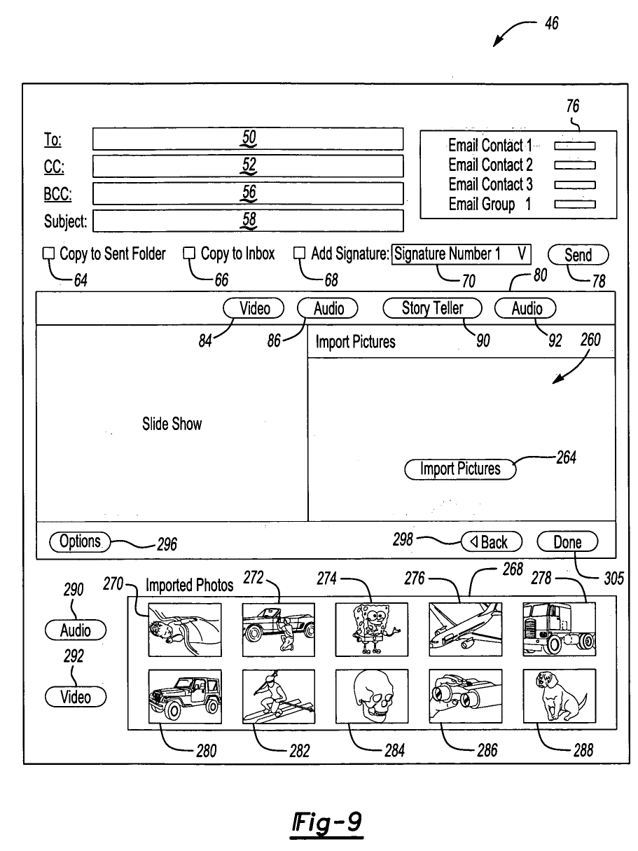

FIG. 9 illustrates the window 80 configured for adding a slide show multi-media file, which appears with selection of the “Story Teller” button 90. The selection of the “Story Teller” button 90 prompts the GUI to reconfigure the applet running in the window to provide a menu 260 for creating the slide show file. The slide show file generally consists of an automated slide-show of digital pictures, which can also include video and/or audio as narration.

An “Import Pictures” button 264 is selected for compiling the pictures that are to comprise the presentation. The pictures are typically digital pictures, such as those take by a digital camera and the like, but they can be other pictures, such as drawings and/or scanned images. Because the desired pictures are most likely to have been taken remotely from the computer, the “Import Pictures” button 264 initiates a file browsing program (not shown) to locate pictures previously stored on the computer 14 or on a server. The present invention, however, contemplates that the “Import Pictures” button 264 can be used to initiate a picture program for taking a picture with a peripheral device without requiring the user to exit the email application, much like the recording of the video and the audio described above.

The file names of the desired pictures are selected from the browsing program for display in a picture window 268 that includes thumbnails 270-288 for each of the selected pictures. One or more pictures can be selected for the presentation. The presentation, when viewed by the recipient, automatically displays each picture for a predefined period of time before switching to the next picture. The order of display begins with the picture of thumbnail 270 and continues sequentially through thumbnail 288. Of course, more or less thumbnails can be included without deviating from the scope and contemplation of the present invention.

Each of the thumbnails 270-288 can be dragged and dropped, such as with a left-click on a mouse, around the window 268 with the pointer to change the position of the corresponding picture within the presentation. If the pointer is a mouse, for example, a right-click on the mouse can be used to change the properties of the picture, such as its resolution, to delete it from the presentation, and to perform other editing functions, such as cropping and the like. An “Audio” button 290 and a “Video” button 292 are selected to add audio and/or video to the slide show. The previously described menus 144 and 96 for recording audio and video, respectively, appear with selection of the “Audio” button 290 and the “Video” button 292. The audio can be recorded, for example, as a narration feature so that it can be played during the slide show to narrate the changing pictures. The video can be recorded, for example, to provide an introductory message and/or a concluding message that plays before or after the slide show. An “Options” button 296 is selected to display an options menu (not shown) that can be used to control the slide show, such as the time between switching pictures and the association of the audio/video with the slide show.

A “Back” button 298 is selected to return to the menu shown in FIG. 3. A “Done” button 305 is selected once the editing of the slide show is completed to return to the menu shown in FIG. 3 so that the message can be sent or so that additional multi-media files can be added.

Once one or more of the desired multi-media files are attached to the message, the message is sent with the attached multi-media files with selection of the “Send” button 78. The message is sent from the computer 14 over the network 18 to the server 22. In accordance with one aspect of the present invention, the server 22 is configured to save the multi-media file in a memory of the server and then separately send an email to each recipient that includes the text message and other inputted data, but which replaces the attached multi-media file(s) with a link to a portion of the server 22 in which the multi-media file is stored.

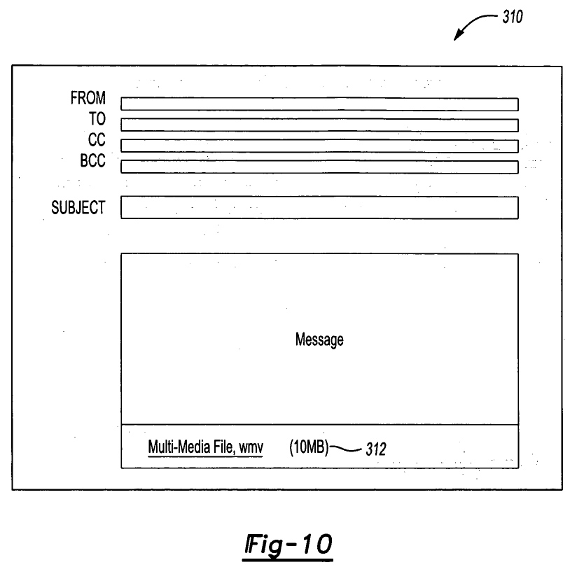

FIG. 10 illustrates an exemplary message 310 sent from the server 22 to the recipient computer 26 that includes a link 312 to the multi-media file stored on the server 22. The link 312 can be clicked on, such as with a left-click on a mouse, to direct a web browser operation on the recipient's computer 26 to the server 22 to view the multi-media file from a webpage hosted by the server and/or the link can be clicked on, such as with a right-click on a mouse, to download the file to the computer 26. The size of the file and its type, such as a wmv video file, is shown in the link so that the recipient can determine whether to download the file based on the size and type of the file.

In accordance with one aspect of the present invention, any one of the multi-media files can be viewed from the webpage of the server without requiring the recipient to download large multi-media files to their computer. Moreover, each multi-media file is recorded and/or compiled under standard webpage protocols, such as “html,” and the webpage includes capabilities for executing programs, such as Java applets and ActiveX controls, so that the recipient can easily view the multi-media files from their web browser without having to run a proprietary program.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for sending electronic mail (email), the system comprising:
a computer having an email application for composing and sending an email message, the email message specifying a recipient email address for a recipient of the email message, wherein the email application includes a multi-media feature for associating a multi-media file with the email message without exiting the email application; and
a server in communication with the computer for relaying the email message to the recipient email address, wherein the server removes the multi-media file from the email message and adds a link in place thereof when the server relays the email message to the recipient email address, the removed multi-media file being accessible by clicking on the link in the email message.

2. The system of claim 1 wherein the removed multi-media file is stored on a memory of the server for access through the link.

3. The system of claim 1 wherein the multi-media feature is a multi-media application integrated within the email application so that the multi-media file can be added while operating inside the email application.

4. The system of claim 3 wherein the multi-media file is added by creating the multi-media file with the multi-media application.

5. The system of claim 3 wherein the multi-media files is added by importing the multi-media file with the multi-media application.

6. The system of claim 5 wherein the file is imported from a network.

7. The system of claim 5 wherein the multi-media application provides a file browser for importing the multi-media file.

8. The system of claim 3 wherein the multi-media file is a video file, and wherein the multi-media application is configured to automatically add the video file to the email message.

9. The system of claim 8 wherein the multi-media application provides a window in the email application having selectable buttons for controlling a recording of the video file from a peripheral device in communication with the computer.

10. The system of claim 3 wherein the multi-media file is an audio file, and wherein multi-media the application is configured to automatically add the audio file to the email message.

11. The system of claim 10 wherein the multi-media application provides a window in the email application having selectable buttons for controlling a recording of the audio file from a peripheral device in communication with the computer.

12. The system of claim 3 wherein the multi-media file is a greeting card file, and wherein the multi-media application is configured to automatically add the greeting card file to the email message.

13. The system of claim 12 wherein the multi-media application provides a window in the email application having a plurality of selectable greeting card thumbnails, the greeting card thumbnails displaying an image associated with the greeting card and being selectable for creating the greeting card associated with the thumbnail image.

14. The system of claim 12 wherein the multi-media application provides a window in the email application having a plurality of selectable greeting card options, the greeting card options being selectable for customizing the greeting card.

15. The system of claim 3 wherein the multi-media file is a slide show presentation file, and wherein the application is configured to automatically add the slide show file to the email.

16. The system of claim 15 wherein the multi-media application provides a window in the email application having a plurality of selectable buttons for locating digital pictures and incorporating the pictures into the slide show.

17. The system of claim 16 wherein one of the buttons adds video to the slide show presentation file.

18. The system of claim 16 wherein on the buttons add audio to the slide show presentation file.

19. The system of claim 1 wherein the server plays the multi-media file in response to the user selecting the link so that the multi-media file is viewable without requiring a recipient to download the multi-media file.

20. The system of claim 19 wherein the multi-media files is payed using standard protocols so that the multi-media file is viewable without requiring a recipient to download an application to view the multi-media file.

21. The system of claim 20 wherein the standard protocol is sufficient to view the multi-media file from a web browser.

22. A graphical user interface (GUI) for adding a multi-media file to an email message, the GUI configured to:
operate as an email applet within a composition window of an email application in which the email message is composed; and
create a multi-media file for association with the email message.

23. The GUI of claim 22 wherein the multi-media file is a video file, and wherein the GUI is configured to create the video file.

24. The GUI of claim 22 wherein the multi-media file is an audio file, and wherein the GUI is configured to create the audio file.

25. The GUI of claim 22 wherein the multi-media file is a greeting card file, and wherein the GUI is configured to create the greeting card file.

26. The GUI of claim 22 wherein the multi-media file is a slide show presentation file, and wherein the GUI is configured to create the slide show presentation file.

27. A method for electronic messaging, the method comprising:
accessing an email application on a sender computer;
creating an email message within the email application, the email message including a recipient email address;
adding a multi-media file within the email application without exiting the email application;
associating the multi-media file to the email message;
delivering the email message with the multi-media file to a server;
removing the multi-media file from the email message when the email message reaches the server;
storing the removed multi-media file on a memory of the server;
replacing the removed multi-media file with a link in the email message, the removed multi-media file being accessible by clicking on the link in the email message; and
delivering the email message to the recipient email address, the delivered email message including the link in place of the multi-media file.

28. The method of claim 27 wherein the multi-media file is a video file.

29. The method of claim 27 wherein the multi-media file is an audio file.

30. The method of claim 27 wherein the multi-media file is a greeting card file.

31. The method of claim 27 wherein the multi-media file is a slide show presentation file.

32. The method of claim 27 further comprising logging in and authenticating a user when prior to accessing the email application.

33. The method of claim 32 wherein a type of multi-media file that can be added is based at least in part on the logged in and authenticated user.
